(19) United States
(12) Patent Application Publication
(10) Pub. No.: US 2018/0310488 A1
(43) Pub. Date: Nov. 1, 2018

(54) GREEN CONSTRUCTION ELEMENT AND METHOD FOR THE PRODUCTION THEREOF

(71) Applicant: LAFARGE, Paris (FR)

(72) Inventors: Gilles LECOMTE, SAINT QUENTIN FALLAVIER (FR); Benjamin RILEY, SAINT QUENTIN FALLAVIER (FR); François DE LARRARD, SAINT QUENTIN FALLAVIER (FR); Isabelle DUBOIS-BRUGGER, SAINT QUENTIN FALLAVIER (FR)

(21) Appl. No.: 15/768,393

(22) PCT Filed: Oct. 14, 2016
(86) PCT No.: PCT/FR2016/052668

§ 371 Date: Apr. 13, 2018

(30) Foreign Application Priority Data
Oct. 14, 2015 (FR) 1559761

(51) Int. Cl. A01G 9/02; E04C 2/04; C04B 28/04; C04B 28/30; C04B 28/06; C04B 18/02; C04B 14/28; C04B 14/10; C04B 41/00; C04B 41/46; C04B 41/82

(52) U.S. Cl. CPC A01G 9/025; E04C 2/044; C04B 28/04; C04B 28/30; C04B 28/06; C04B 2111/00103; C04B 14/28; C04B 14/106; C04B 41/009; C04B 41/46; C04B 41/82; C04B 18/02

(57) ABSTRACT

A green construction element forming a vertical surface of the construction, the element including a porous concrete element and a coating on at least one of the surfaces of the porous concrete, directly in contact with the surface, the coating, which is favourable to the development of plants, including a plant or a seed of the plant, and the porous concrete having a porosity of between 10% and 40% in the hardened state thereof, before application of the coating, so as to be able to render the vertical surface of the construction green.

The present invention relates to the field of rendering objects green in the construction sector, in particular walls. The present invention pertains to a green construction element comprising seeds which can germinate and form a plant.

Rendering construction elements green is a practice that is more and more widespread and increasingly sought after, notably for aesthetic, thermal or phonic insulation and air or water quality reasons. The covering of surfaces with plants thus makes a real contribution to the quality of life of inhabitants of urban areas.

In the field of soil stabilisation, hydraulic binders, comprising seeds, intended to be sprayed onto the ground to vegetate have already been proposed (cf. for example EP 736 587). However, apart from problems encountered in succeeding in making the seeds germinate, these binders are only intended to cover relatively horizontal surfaces. It cannot be envisaged to use such binders to manufacture construction elements, notably walls.

Methods already exist which make it possible to render walls green. However, existing methods, such as Skyflor® (WO2011/086518), are extremely expensive. They are based on a complex system employing a bearing element and a very porous ceramic. Between the bearing element and the very porous ceramic is earth with nutriments and seeds. The ceramic used is very expensive and requires a lot of energy during manufacture.

Generally speaking, all existing green walls are luxury objects (cost per m² of several hundreds of euros), require important upkeep and are reserved for prestigious projects.

Conversely, it is sought with the present invention to develop a technology for rendering towns and cities green having reduced initial cost and reduced upkeep cost.

In order to meet the requirements of users and the need to render towns and cities green, it has become necessary to provide green construction elements or elements comprising seeds which can germinate and form a plant, easy to manufacture and cheap.

In an unexpected manner, the inventors have demonstrated that it is possible to propose a porous concrete construction element directly in contact with a vegetated coating or in which seeds have been integrated beforehand. This element will make it possible to build a green construction on at least one of its vertical surfaces. Moreover, to produce green walls, it is proposed to pour the concrete in place, in particular vertically.

It is to be noted that, in existing green walls, the concrete only intervenes as a structure supporting other materials on which the vegetation develops (metal grids, geotextiles, porous ceramics, flower boxes, etc.). Conversely, in the present invention, the concrete itself serves as receptacle for the seeds, then for the roots of the plants, without these threatening its longevity.

### Definitions and Measurement Methods

The expression “self-placing concrete” is taken to mean according to the present invention very fluid concretes, which can be put in place and reach their target porosity under the effect of gravity alone, without it being necessary to vibrate the concrete during the implementation thereof. Self-placing concretes also have the property of leading after hardening to a homogenous final product, not having undergone segregation. Whereas conventional self-placing concretes comprise a considerable volume of binder grout, greater than the porosity of the granular skeleton, of interest here are porous concretes in which the grout content is sufficient to enable a tightening of the skeleton by gravity.

The expression “hydraulic binder” is taken to mean according to the present invention a powdery material which, when mixed with water, forms a grout which sets and hardens following hydration reactions and which, after hardening, conserves its strength and its stability even under water.

The expression “magnesia binder” is taken to mean according to the present invention a hydraulic binder based on magnesia and magnesium chloride or sulphate. Such binders are for example described in the patent application EP 378 010.

The expression “aluminous cement” is taken to mean according to the present invention a calcium aluminate hydraulic binder such as Ciment Fondu.

The expression “mineral additions” or “particulate material” is taken to mean according to the present invention one or more particulate materials having a D90 less than 200 μm. The D90, also noted DV90, corresponds to the 90th percentile of the size volume distribution of the grains, that is to say that 90% of the grains have a size less than D90 and 10% have a size greater than D90.

The expression “plastifier/superplastifier/water reducer” is taken to mean according to the present invention an adjuvant which, without modifying the consistency, makes it possible to reduce the water content of a given concrete, or which, without modifying the water content, increases the slump/the spread thereof, or which produces both effects at the same time. The standard EN 934-2 specifies that the reduction of water must be greater than 5%.

The expression “superplastifier” or “superfluidifier” or “super water reducer” or “high water reducer”, is taken to mean according to the present invention a water reducer that makes it possible to reduce by more than 12% the quantity of water needed to produce a concrete (standard EN 934-2).

The expression “vertical” is taken to mean according to the present invention the direction of the Earth's gravity field, towards the centre of the Earth, more or less 20°, advantageously more or less 10°.

The expression “construction” is taken to mean according to the present invention a built structure or edifice, in particular a building, a house, a monument, an engineering work, perimeter walls, etc.

Later in the description, unless stated otherwise, the proportions indicated by percentages correspond to weight proportions. However, the porosity of a concrete is expressed by a percentage with respect to the volume of the final hardened concrete.

Laser Particle Size Method

The D90 for the different powders was obtained from particle size curves of the curves determined by a Malvern laser particle size counter of Mastersizer 3000 Scirocco type. The particle size must be 0.02 μm to 2 mm. The light source was constituted of a red He—Ne laser (632 nm) and a blue diode (466 nm). The optical model was that of Fraunhofer, the computing matrix was of polydisperse type.

Method for Measuring the Spread of the Hydraulic Binder Grout

The principle of measuring spread consists in filling a test cone for measuring grout spread with the hydraulic binder grout to be tested (in the absence of fine gravel) then releasing the grout from the test cone for measuring grout spread in order to determine the diameter of the disc obtained when the hydraulic binder grout has finished spreading. The test cone for measuring grout spread has the following dimensions:
diameter of the circle of the upper base: 50 mm+/−0.5 mm;
diameter of the circle of the lower base: 100 mm+/−0.5 mm; and
height: 150 mm+/−0.5 mm.

The entire operation was carried out at 20° C. The spread measurement was carried out in the following manner:
Filling the reference test cone in one go with the hydraulic binder grout to test;
Spreading the hydraulic binder grout in a homogeneous manner in the test cone;
Levelling off the upper surface of the cone;
Raising the test cone vertically; and
Measuring the spreading according to four diameters at 45° with a caliper. The result of the spread measurement was expressed as the average of four values, +/−1 mm.

Method of Measuring the Porosity of a Porous Concrete Element

A porosity measurement could be carried out on fresh concrete or hardened concrete.

On fresh concrete, the method consisted in filling with fresh concrete a recipient of known internal volume (preferentially cylindrical and non-deformable), weighing the whole assembly, then subtracting from the measurement result the weight represented by the recipient. The density of the fresh concrete corresponded to the ratio between the measured weight of concrete and the internal volume of the recipient. The compactness of the fresh concrete corresponded to the ratio between the density of the fresh concrete and the theoretical density without porosity of the concrete. It is a value between 0 and 1. The porosity was equal to the unit 1 minus the compactness (1-compactness).

On hardened concrete, the method consisted in using a cylindrical hardened concrete test specimen of 11 cm diameter and 22 cm high which was placed in a recipient of which the internal volume corresponded to the dimensions of the sample. The totality of the internal volume of the recipient was filled with water, the sample then being completely immersed in water. The porosity corresponded to the ratio between the volume of water added and the internal volume of the recipient.

Method of Measuring the Compressive Strength

Whatever the time period, the compressive strength was measured on a cylindrical sample having a diameter of 11 cm and a height of 22 cm according to the standard EN 12390-3: 2001 “Testing hardened concrete—Part 3: Compressive strength of test specimens”.

The invention thus relates to a green construction element, forming a vertical surface of the construction, said element comprising:
a) a porous concrete element and
b) a coating, on at least one of the surfaces of said porous concrete, directly in contact with said surface, favourable to the development of plants comprising a plant or a seed of said plant,
   the porous concrete has a porosity of between 10% and 40% in the hardened state thereof, before application of the coating.

Thus, the invention enables a construction to be rendered green on at least one of its vertical surfaces.

The construction element according to the invention comprises a porous concrete element, which thus constitutes a part of the green element, on which a coating has been applied.

The porosity of the porous concrete enables anchorage of roots and plant growth by retaining nutriments and moisture.

According to one exemplary embodiment of the present invention, the porosity of the concrete in the hardened state, before application of the coating, is between 25% and 35%, preferably between 28% and 35%, more preferentially between 30% and 35%, even more preferentially strictly greater than 30%.

It is particularly interesting to use a porous concrete which enables a self-supporting element to be obtained. Advantageously, the compressive strength, as measured by the method given previously, of the porous concrete element after 28 days is at least 3 MPa, advantageously between 3 MPa and 30 MPa, more advantageously between 3 MPa and 15 MPa, even more advantageously between 6 MPa and 13 MPa.

It is particularly interesting to use a porous concrete element that is also self-placing, that is to say capable of being put in place and reaching the target porosity under the effect of gravity alone.

The concrete according to the invention advantageously comprises, per cubic metre of fresh concrete:
300 kg to 400 kg of a hydraulic binder and 80 litres to 110 litres of water, the ratio between the weight of water and the weight of hydraulic binder being between 0.2 and 0.35; and
1050 kg to 2000 kg of aggregates of which the diameter varies from 4 mm to 15 mm.

The aggregate is generally an aggregate of silica or limestone or a mixture of different types of aggregates. They may be rounded or crushed aggregates, preferably a rounded aggregate. The aggregate may also come from former recycled concrete.

According to one exemplary embodiment of the present invention, the diameter of the aggregates varies from 4 mm to 15 mm, preferably from 6 mm to 10 mm.

Advantageously, the concrete does not comprise sand. Thus, the content by weight, per cubic metre of fresh concrete, of aggregates of which the diameter is less than 4 mm is less than 50 kg, advantageously is zero.

Suitable hydraulic binders are:
Portland clinker based binders. A Portland clinker is obtained by clinkerisation at high temperature of a mixture comprising limestone and clay. For example, a Portland clinker is a clinker as defined in the standard NF EN 197-1 of February 2001 or as described in the publication “Lea's Chemistry of Cement and Concrete”. Portland cements include slag cements, pozzolan, fly ashes, burnt schists, limestone and compound cements. It is for example a cement of type CEM I, CEM II, CEM III, CEM IV or CEM V according to the standard “Cement” NF EN 197-1 of February 2001;
binders based on sulphoaluminate clinker, in particular based on belite sulphoaluminate clinkers. Belite sulphoaluminate clinkers are clinkers having a low alite content, in particular an alite content less than or equal to 5% by weight, or not having any alite. Alite is one of the “mineralogical phases” (designated “phases” later in the description) of known clinkers of Portland type. Alite comprises tricalcium silicate Ca₃SiO₅. The belite sulphoaluminate clinker may for example be obtained according to the method described in the patent application WO 2006/018569;
magnesia binders. A magnesia binder is based on magnesia and magnesium chloride or sulphate. A binder based on magnesia and partially dehydrated magnesium salt is particularly used, preferably a magnesium salt having an average hydration level, expressed in molecules of water per molecule of magnesium salt, comprised between 0 and around 5, again preferably comprised between around 2 and around 4.
Calcium aluminate binders. A calcium aluminate binder is based on calcium aluminate, such as Ciment Fondu and is obtained by calcination of a mixture of bauxite and limestone.

Thus, the binder advantageously comprises a Portland clinker based cement as defined in the European standard EN 197-1 or a cement based on sulphoaluminate clinker, or a magnesia binder, or a calcium aluminate cement.

The hydraulic binder may further comprise a particulate material (or mineral addition) having a D90 less than 200 μm, or a mixture of particulate materials.

Examples of mineral additions are fly ashes (as defined in the standard EN 450), pozzolanic materials (as defined in the standard NF P 18-513), silica fumes (as defined in the standard NF EN 13263-1), blast furnace slags (as defined in the standard NE EN 15167-1), calcinated schists (as defined in the “Cement” standard NF EN 197-1 paragraph 5.2.5), limestone additions (as defined in the standard NF P 18-508) and silica additions (as defined in the standard NF P 18-509), or mixtures thereof.

The mineral additions advantageously comprise pozzolanic materials, or a mixture thereof.

Suitable pozzolanic materials comprise silica fumes, also known by the name of micro-silica, which are a by-product from the production of silicon or ferrosilicon alloys. It is known as a highly reactive pozzolanic material. Its main constituent is amorphous silicon dioxide. The individual particles generally have a diameter of around 5 nm to 10 nm. The individual particles agglomerate to form agglomerates of between 0.1 μm and 1 μm, and then can agglomerate together in agglomerates of between 20 μm and 30 μm. The silica fumes generally have a BET specific surface area of between 10 m²/g and 30 m²/g.

Other pozzolanic materials comprise materials rich in aluminosilicate such as metakaolin, and natural pozzolans having volcanic, sedimentary, or diagenetic origins.

The pozzolanic material is advantageously selected from metakaolins, silica fume and mixtures thereof.

The mineral additions also comprise ground limestone, advantageously combined with pozzolanic materials. According to an alternative of the invention, the hydraulic binder further comprises a mineral addition, advantageously at a level such that the pH of the interstitial solution after 28 days is below 12, more advantageously below 11, in particular ranging from 9 to 11.

The porous concrete, advantageously self-placing, according to the invention may comprise a plastifier (or water reducer) or a superplastifier. Preferably, the concrete comprises a superplastifier.

The water reducers may, for example, be based on lignosulphonic acids, hydroxycarboxylic acids or treated carbon hydrates and other specialised organic compounds, for example glycerol, polyvinyl alcohol, sodium alumino-methyl-siliconate, sulphanilic acid and casein.

A superplastifier has a fluidifying action since, for a same quantity of water, the workability of the concrete is increased in the presence of the superplastifier. Superplastifiers have been classified in a general manner into four groups: condensate of sulphonated naphthalene formaldehyde (SNF) (generally a sodium salt); or condensate of sulphonated melamine formaldehyde (SMF); modified lignosulphonates (MLS); and others.

An example of new generation superplastifier comprises compounds comprising a carbon chain comprising heteroatoms and having at one end one or more phosphate groups. Another example of new generation superplastifier comprises polycarboxylic compounds such as polyacrylates. The superplastifier is preferably a new generation superplastifier, for example a copolymer comprising polyethylene glycol as graft and carboxylic functions in the main chain such as a polycarboxylic ether. Sodium polysulphonates-polycarboxylates and sodium polyacrylates may also be used. In order to reduce the total quantity of alkalines, the superplastifier may be formulated as a calcium salt rather than as a sodium salt.

The concrete may comprise, moreover, a superplastifier comprising a polymer comprising a main chain to which are bound more than three side chains. Preferably, the dry content weight percentage of the plastifier or superplastifier varies from 0.05 to 1.0%, more preferentially from 0.2 to 0.5%, compared to the weight of hydraulic binder (the hydraulic binder comprising the cement and the optional mineral additions).

Other adjuvants may be added to the concrete according to the invention, for example, an antifoaming agent (for example, polydimethylsiloxane). They may also be silicones in the form of a solution, a solid or preferably in the form of a resin, an oil or an emulsion, preferably in water. More particularly suitable silicones comprise the characteristic groups (RSiO_{0.5}) and (R₂SiO). In these formulas, the radicals R, which may be identical or different, are preferably hydrogen or an alkyl group with 1 to 8 carbon atoms, the methyl group being the preferred group. The number of characteristic groups is preferably from 30 to 120. The quantity of such an agent in the concrete is generally at most 5 parts by weight compared to the cement.

The concrete according to the invention may also include anti-efflorescence agents (to control primary and/or secondary efflorescence). These agents comprise formulations comprising a water-repellent acid compound, for example a liquid mixture of fatty acid (for example a tall oil fatty acid which may comprise a fatty acid insoluble in water, a rosinic acid or a mixture thereof) or a silane-siloxane as defined in the patent FR2978759 for primary efflorescence and aqueous mixtures comprising a calcium stearate dispersion (CSD) for secondary efflorescence. The anti-efflorescence agents controlling primary and secondary efflorescence comprise compositions comprising a water-repellent acid compound, generally selected from fatty acids, rosinic acids and mixtures thereof and an aqueous calcium stearate dispersion. The term calcium stearate dispersion generally signifies a dispersion of calcium stearate, calcium palmitate, calcium myristate or a combination thereof. Silicates, for example alkaline silicates, may also be included in the concrete according to the invention to combat efflorescence. Similar products may be used as surface treatments on the hardened concrete according to the invention.

The concrete according to the invention may comprise a viscosity modifying agent and/or a yield stress modifying agent (generally to increase the viscosity and/or the yield stress). Such agents comprise:
cellulose derivatives, for example water soluble cellulose ethers, such as sodium carboxymethyl, methyl, ethyl, hydroxyethyl and hydroxypropyl ethers;
alginates;
xanthan, carrageenan or guar gum;
polyethylene glycol and propylene glycol;
polyvinyl alcohol; or
polyacrylamide.
   A mixture of these agents may be used.

The porous concrete, advantageously self-placing, according to the invention may comprise an activating agent which makes it possible to speed up the hydration reactions of vitreous materials. Such agents comprise sodium and/or calcium salts.

The porous concrete according to the invention may comprise an accelerator and/or a retarder.

The concrete according to the invention may comprise, per cubic metre of fresh concrete, between 150 litres and 250 litres of a hydraulic binder grout and water. In particular, the concrete according to the invention may comprise, per cubic metre of fresh concrete:
180 kg to 340 kg, advantageously 200 kg to 340 kg, of hydraulic binder;
0 kg to 140 kg, advantageously 0 kg to 120 kg, of a mineral addition having a D90 less than 200 μm;
0.7 kg to 1.2 kg, advantageously 0.8 kg to 1.0 kg, of dry content of superplastifier;
1400 kg to 1750 kg, advantageously 1500 kg to 1600 kg, of aggregates of which the diameter varies from 4 mm to 15 mm;
80 litres to 100 litres, advantageously 85 litres to 95 litres, of water.

Advantageously, the concrete according to the invention comprises, per cubic metre of fresh concrete, less than 50 kg of aggregates of which the diameter is less than 4 mm (sand), more advantageously 0 kg of aggregates of which the diameter is less than 4 mm.

The hydraulic binder grout preferably has a Vicat setting time less than 24 hours, preferably less than 10 hours.

The W/B ratio, where W designates the quantity of water in kilograms and B the quantity of binder in kilograms (comprising the cement and the mineral additions when these are present), varies from 0.2 to 0.35 preferably from 0.25 to 0.35, more preferentially from 0.28 to 0.35.

The porous concrete, advantageously self-placing, according to the invention advantageously has a spread, measured according to the method described previously, ranging from 280 mm to 380 mm, advantageously from 310 mm to 350 mm.

The porous concrete may be prepared by known methods, notably the mixing of solid components and water, putting it in place then hardening.

According to one exemplary embodiment, the method for manufacturing a porous concrete according to the invention may comprise mixing the constituents of the porous concrete, putting in place the porous concrete, in particular pouring in place, in a mould or in a formwork. Preferably, the manufacturing method does not comprise a step of compacting the porous concrete.

The coating advantageously comprises a nutritive support and optionally cement.

According to the present invention, a nutritive support may be earth (for example as defined according to lines 1.1 and 1.2 of table 1 and lines 2.14 to 2.16 of table 2 of the standard NF U44-551 of May 2002), sand (for example as defined according to line 1.3 of table 1 of the standard NF U44-551 of May 2002), volcanic rock (for example as defined according to line 1.4 of table 1 of the standard NF U44-551 of May 2002), clay (for example as defined according to line 1.5 of table 1 of the standard NF U44-551 of May 2002), expanded clay (for example as defined according to line 1.6 of table 1 of the standard NF U44-551 of May 2002), expanded schist (for example as defined according to line 1.7 of table 1 of the standard NF U44-551 of May 2002), perlite (for example as defined according to line 1.8 of table 1 of the standard NF U44-551 of May 2002), expanded vermiculite (for example as defined according to line 1.9 of table 1 of the standard NF U44-551 of May 2002), ground polystyrene (for example as defined according to line 1.10 of table 1 of the standard NF U44-551 of May 2002), a mineral substrate (for example as defined according to line 1.11 of table 1 of the standard NF U44-551 of May 2002), a mineral wool (for example as defined according to line 1.12 of table 1 of the standard NF U44-551 of May 2002), a blond sphagnum peat (for example as defined according to line 2.1 of table 2 of the standard NF U44-551 of May 2002), a sphagnum peat (for example as defined according to line 2.2 of table 2 of the standard NF U44-551 of May 2002), a brown peat (for example as defined according to line 2.3 of table 2 of the standard NF U44-551 of May 2002), a peat bog earth (for example as defined according to line 2.4 of table 2 of the standard NF U44-551 of May 2002), a pine bark (for example as defined according to line 2.5 of table 2 of the standard NF U44-551 of May 2002), a coniferous tree bark (for example as defined according to line 2.6 or 2.8 of table 2 of the standard NF U44-551 of May 2002), a broad-leaved tree bark (for example as defined according to line 2.7 or 2.8 of table 2 of the standard NF U44-551 of May 2002), a composted bark (for example as defined according to line 2.9 of table 2 of the standard NF U44-551 of May 2002), a wood fibre (for example as defined according to line 2.10 of table 2 of the standard NF U44-551 of May 2002), a coconut fibre (for example as defined according to line 2.11 of table of the standard NF U44-551 of May 2002), a plant matter having undergone physical treatment and optionally composting (for example as defined according to line 2.12 or 2.13 of table 2 of the standard NF U44-551 of May 2002), an organic-mineral substrate (for example as defined according to line 2.17 of table 2 of the standard NF U44-551 of May 2002), or mixtures thereof.

Preferably, the nutritive support is earth, compost or a mixture of earth and compost.

The term “earth” is generally taken to mean any topsoil, any support earth, any compost, any peat optionally forest based as described in the standard NF U44-551 of May 2002 (see in particular table 1 page 10 and table 2 page 21 of the standard).

The term “support earth” is generally taken to mean any earth from humus bearing surface horizons or deep soil horizons which can be mixed with mineral matter. A support earth generally comprises between 1 and 5% by weight of organic matter compared to the dry weight of earth.

The term “topsoil” is generally taken to mean any earth from surface humus-bearing horizons or deep soil horizons which can be mixed with organic matter of plant origin, organic soil builders and/or mineral matter. A support earth generally comprises between 3 and 15% by weight of organic matter compared to the dry weight of earth.

The term “compost” is generally taken to mean any mixture composed mainly of organic plant matter which can comprise organic matter, mineral matter, earth and synthetic material. A compost generally comprises more than 40% by weight of organic matter compared to the dry weight of compost.

The term “peat” is generally taken to mean any acid mixture composed mainly of organic plant matter which can comprise organic matter, mineral matter and synthetic matter. A peat generally comprises more than 30% by weight of organic matter compared to the dry weight of earth.

The term “forest peat” is generally taken to mean any earth coming uniquely from acid humus-bearing soil horizons of sandy soils, which cannot be mixed or supplemented. A forest peat generally comprises more than 25% by weight of organic matter compared to the dry weight of earth.

Preferably, the nutritive support may further comprise a fertilizer (for example as defined according to line 3.1 of table 3 of the standard NF U44-551 of May 2002), a synthetic water retainer (for example as defined according to line 3.2 of table 3 of the standard NF U44-551 of May 2002) and/or a wetting agent (for example as defined according to line 3.3 of table 3 of the standard NF U44-551 of May 2002).

The coating may comprise, apart from earth, compost or earth/compost mixture, elements favouring the sprouting of a plant. These elements may in particular be nutritive elements and/or protectors and/or adhesives and/or which stimulate germination.

For example, the nutritive elements may be fertilizers. For example, the protective elements may be phytosanitary products. For example, the adhesive elements may be resin. For example, the elements which stimulate germination may be at least one fertilizer, for example a germination hormone or a growth hormone.

According to a particular example, the nutritive elements may be a clay comprising organic matter, or a pozzolan. When the plant is a leguminous plant, the compost may also further comprise rhizobacteria.

The coating according to the invention comprises a seed or a plant, as is described hereafter.

The coating according to the present invention may also comprise cement.

The addition of a small percentage of cement to the coating enables better adhesion of the coating on the porous concrete and stability with respect to gullying.

Preferably, the coating comprises between 0 and 5% of cement, advantageously between 0 and 3% of cement, by weight compared to the total weight of the coating.

The coating according to the present invention may also comprise anti-polluting elements, for example activated carbon, optionally associated with plants known for their anti-polluting action.

The porous concrete could be coupled with a structural concrete for questions of sealing and bearing function, when these have to be ensured by the wall.

Thus, the green construction element according to the invention could further comprise a layer made of structural concrete. This structural concrete will be advantageously in direct contact with the non-green surface of the porous concrete element.

The green construction element according to the invention may constitute any object in the construction sector, in particular walls. The green construction element constitutes a vertical surface of the construction thus making it possible to render this vertical surface green.

The green construction element according to the invention could comprise a water intake element notably a watering element, advantageously integrated in the porous concrete, more advantageously in its upper part. Three options may be envisaged:
a pierced pipe laid on the upper surface of the porous concrete;
a similar pipe inserted in the upper part of the concrete layer;
channelling rain water streaming from the roof into the porous concrete.

The invention also relates to a method for preparing a green construction element comprising
The preparation of a porous concrete element, as defined previously; then
The application of a seeded coating, as defined previously.

The porous concrete will advantageously be poured in place.

Preferably, the coating comprises between 0.03% and 0.10% of a seed, by weight compared to the total weight of the coating.

The term “seed” is taken to mean according to the present invention any element of a plant capable of forming a complete plant. A seed may for example be a seed, a rhizome or a spore. For example, according to the invention, the seeds, the rhizomes and the spores may be selected from leguminous plants, succulents, calcicolous plants, stolon plants and ligneous plants.

A plant may for example be a flowering plant, a moss, a lichen, a fungus or a fern.

The term “flowering plant” is generally taken to mean any plant belonging to the division of Magnoliophyta, also called angiosperm.

The term “moss” is generally taken to mean any plant belonging to the branch of Bryophyta. This branch comprises three divisions: Hepaticophyta, Anthocerotophyta and Bryophyta.

The term “lichen” is generally taken to mean a symbiotic plant formed by the association of a microscopic alga and a filamentous fungus.

The term “fungus” is generally taken to mean a plant with little differentiated tissues, without chlorophyll, formed of networks of filaments, and which reproduces by means of spores.

The term “fern” is generally taken to mean any plant belonging to the division of Pteridophyta.

The term “leguminous” is generally taken to mean any plant belonging to the Fabaceae family. For example, the leguminous plants may belong to a sub-family selected from Caesalpinoideae, Mimosoideae and Faboideae. For example, bean, pea, lentil, groundnut, soya, liquorice, alfalfa, clover, lupin, wisterias or rosewood may be cited.

The term “succulent” is generally taken to mean any plant capable of surviving in arid environments. For example, the succulents may belong to a family selected from Aizoaceae, Agavaceae, Apocynaceae, Asphodelaceae, Cactaceae, Crassulaceae, Cucurbitaceae, Didiereaceae, Euphorbiaceae, Geraniaceae and Portulacaceae.

The term “calcicolous” is generally taken to mean any plant capable of surviving on calcium rich soils. For example, calcicolous plants may be selected from Sansevieria, Titanopsis, Thelocactus, Bupleurum falcatum, Digitalis lutea, Geranium sanguineum, Helleborus foetidus, Hepatica nobilis, Inula conyza, Lactuca perennis, Laserpitium latifolium, Origanum vulgare, Teucrium chamaedrys, Orchis mascula and Orchis purpurea.

The term “stolon plant” is generally taken to mean any plant having or capable of producing a stolon. For example, the stolon plant may belong to a genus selected from Argentina, Cynodon, Fragaria, Pilosella. For example the stolon plant may be Zoysia japonica or Ranunculus repens.

The term “ligneous plant” is generally taken to mean any plant that produces lignins, that is to say macromolecules that give the plant its solidity. Wood, which comprises cellulose and lignins, is the main structural tissue of ligneous plants. For example, a ligneous plant may be a tree, a bush, a shrub, a creeper or a sub-shrub. Ligneous plants are particularly suitable for the stabilisation of soils, notably thanks to their rigid roots.

Preferably, the seeds may be prepared before their use in the coating according to the present invention, in order to favour the sprouting of a plant. The seeds may for example be coated, totally or partially, with an envelope, said envelope comprising elements favouring the sprouting of a plant, such as those described previously.

The preparation to favour the germination of the seeds may be any preparation known to those skilled in the art as a function of the seeds used. For example, the seeds may be humidified by vaporisation and/or humidified by soaking and/or split and/or vernalised. For example, the seeds may be placed in water, in a damp fabric or in damp cotton. For example, the seeds may be humidified for a duration comprised between 1 and 5 days, for example for 2 days. The term “vernalisation” is generally taken to mean the cold period undergone by a plant or a seed necessary to make it pass from the vegetative stage to the reproductive stage. Those skilled in the art are able to determine what temperature to apply to a determined seed and for how long it should be vernalised.

The seeded coating is advantageously applied by floating or by spray. Floating consists in applying the coating using a blade (straight edge, trowel, etc.) so as to make it penetrate into the open porosity of the porous concrete, leaving a flat layer of 1 or 2 mm thickness. Spraying enables the same result to be obtained, with often less flatness, but with much greater productivity (technique to reserve for large surfaces). Pressing (floating) or spraying the coating enables the penetration thereof into the open porosity of the concrete draining over several centimetres.

After application of the coating, the seeds germinate and the plants develop without deterioration of the mechanical properties of the porous concrete element.

The examples that follow illustrate the invention without limiting the scope thereof.

### EXAMPLES

In these examples, the materials used are available from the following suppliers:
CEMI 52.5 N PM-ES-CP2-NF, LafargeHolcim, Teil plant Fine gravel 6/10, LafargeHolcim, St Bonnet site (France)
Superplastifier ADVA® Flow 450, Grace Construction Products (abridged ADVA 450 in the tables)

### Metakaolin Lavollée S.A.

Limestone filler Corrière de La Vallee Heureuse

### Method for Preparing the Concrete:

The porous concrete according to the invention was produced with a Zyclos type mixer (50 litres). The entire operation was carried out at 20° C. The preparation method included the following steps:

Placing the aggregates in the bowl of the mixer;

At T=0 second: starting the mixing;

At T=30 seconds: adding the moistening water (3 to 10% of the weight of dry aggregates) then continuing to mix up to 90 seconds;

At T=90 seconds: stopping the mixing and leaving to stand for 4 minutes;

At T=5 minutes and 30 seconds: adding the hydraulic binder;

At T=6 minutes and 30 seconds: mixing for 1 minute;

At T=7 minutes and 30 seconds: adding the remainder of the makeup water over 30 seconds (while mixing); and

At T=8 minutes: mixing for 2 minutes.

### Method of Measuring the Density of the Concrete:

Once the concrete has been prepared, it is placed in a recipient of known internal volume. The density is the ratio between the measured weight of concrete and the internal volume of the recipient.

Two examples of porous concrete according to the invention were produced from cement grouts having the formulations (F1) and (F2) given in the following table:

TABLE 1

| | F1 | F2 |
|---|---|---|
| | Weight of the component in kg | |
| Component | per cubic metre of fresh concrete | |
| Cement CEMI 52.5N | 333.6 | 179.5 |
| PM-ES-CP2-NF | | |
| Aggregates 6-10 mm St Bonnet | 1570.8 | 1570.9 |
| Metakaolin | | 82.5 |
| Limestone filler | | 41.2 |
| ADVA 450 | 3.3 | 3.9 |
| Viscosity modifying agent | 0.011 | |
| Water | 90.0 | 91.0 |

The volume of cement grout was 199 litres (F1) and 202 litres (F2) per cubic metre of fresh concrete.

The binder grout was produced by mixing the cement, if need be the mineral addition, the superplastifier and water.

The spread of the hydraulic binder grout was measured according to the method described above. The results are given in the following table:

TABLE 2

| | F1 | F2 |
|---|---|---|
| Spread of the binder grout (mm) | 310 | 350 |

The porous concretes were produced by mixing the constituents in a mixer and cylindrical test specimens of 11 cm diameter and 22 cm height were produced. The free surface of the porous concrete was leveled off with a straight edge. The cylindrical test specimens were conserved in conditions normalised to test their compressive strength after 7 days then after 28 days.

A measurement of the compressive strength of the concrete was carried out as described above. The test specimen was removed from the mould after 3 days. The porosity of the concrete in the hardened state was measured as has been described above.

B1: concrete obtained with the formulation F1; B2: concrete obtained with the formulation F2 The results are grouped together in the following table:

TABLE 3

| | B1 | B2 |
|---|---|---|
| Compressive strength after 7 days (MPa) | 9.3 | 6.3 |
| Compressive strength after 28 days (MPa) | 10.2 | 9.9 |
| Porosity (%) | 32 | 32 |
| Density (28 days) | 1.7 | 1.7 |

A vertical wall 90 cm high, 40 cm wide and 15 cm thick was poured according to normal construction methods with the concrete composition B1. This composition is validated for the application of this invention because the porous wall is:
of homogenous appearance,
permeable (test carried out by flow of water whilst the wall was in horizontal position),
without apparent cavities, and
without apparent compaction defects.
   On elements made of porous concrete B1 and B2, of dimensions 25 cm×25 cm×10 cm, a seeded coating comprising or not cement is applied by floating or spraying according to the information given in the following tables:

TABLE 4
Composition of the coating

| | |
|---|---|
| E1 | E2 |

| | | | | |
|---|---|---|---|---|
| Earth | 1500 | mL | 1500 | mL |
| Compost | 1500 | mL | 1500 | mL |
| Cement | 450 | mL | 0 | mL |
| Water | 1250 | mL | 1250 | mL |

TABLE 5
Types of seeds and mixture proportions

| | Mixture 1 | Mixture 2 |
|---|---|---|
| Seeds | (g/m³ of concrete) | (g/m³ of concrete) |
| Ruta graveolus | 198 | 396 |
| Aurinia saxatilis | 85 | 170 |
| Cymbalaria muralis | 21 | 42 |
| Sedum acre | 4 | 8 |

The 8 samples are stored and are subjected to the same conditions of light, watering and other environmental conditions. Good germination of all the seeds on all the samples is observed.

1.-17. (canceled)

18. A green construction element, forming a vertical surface of the construction, said element comprising:
a) a porous concrete element, and
b) a coating on at least one of the surfaces of said porous concrete, directly in contact with said surface, said coating which is favourable to the development of plants, comprising a plant or a seed of said plant,
the porous concrete having a porosity of between 10% and 40% in the hardened state thereof, before application of the coating, so as to be able to render said vertical surface of the construction green.

19. The element according to claim 18, wherein the porous concrete has a porosity of between 30% and 35% in the hardened state thereof, before application of the coating.

20. The element according to claim 18, wherein the element is made of porous self-supporting concrete.

21. The element according to claim 20, wherein a compressive strength of the porous concrete element after 28 days is at least 3 MPa.

22. The element according to claim 20, wherein the compressive strength of the porous concrete element after 28 days is between 3 MPa and 30 MPa.

23. The element according to claim 18, wherein the element is made of porous self-placing concrete.

24. The element according to claim 18, wherein the porous concrete comprises per cubic metre of fresh concrete:
300 kg to 400 kg of a hydraulic binder and 80 litres to 110 litres of water, the ratio between the weight of water and the weight of hydraulic binder being between 0.2 and 0.35; and
1050 kg to 2000 kg of aggregates of which the diameter is from 4 mm to 15 mm.

25. The element according to claim 24, wherein the porous concrete does not comprise aggregates of which the diameter is less than 4 mm.

26. The element according to claim 24, wherein the hydraulic binder comprises a cement based on Portland clinker as defined in the European standard EN 197-1 or a cement based on sulphoaluminate clinker, or a magnesia binder, or a calcium aluminate cement.

27. The element according to claim 24, wherein the hydraulic binder further comprises a mineral addition having a D90 less than 200 μm, selected from pozzolanic materials, ground limestone, and mixtures thereof.

28. The element according to claim 27, wherein the pozzolanic material is selected from metakaolins, silica fume and mixtures thereof.

29. The element according to claim 24, wherein the porous concrete further comprises a superplastifier.

30. The element according to claim 29, wherein a dry content weight percentage of the superplastifier varies from 0.05% to 1.0% compared to the weight of hydraulic binder.

31. The element according to claim 24, wherein the porous concrete further comprises a viscosity modifying agent and/or a yield stress modifying agent.

32. The element according to claim 24, wherein the porous concrete comprises between 150 litres and 250 litres of a hydraulic binder grout and water per cubic metre of fresh concrete.

33. The element according to claim 18, wherein the coating comprises a nutritive support and optionally cement.

34. The element according to claim 18, further comprising a structural concrete layer.

35. The element according to claim 34, wherein the structural concrete layer is in direct contact with the non-green surface of the porous concrete element.

36. The element according to claim 18, integrating a water intake element.

37. A method for preparing an element of a green construction according to claim 18, comprising:
preparing a porous concrete element, as defined in claim 18; then
applying a seeded coating by floating or spraying.
